(19) United States
(12) Patent Application Publication
(10) Pub. No.: US 2025/0349847 A1
(43) Pub. Date: Nov. 13, 2025

(54) DUAL BINDER AND DUAL SOLVENT SLURRY COATING PROCESS FOR MAKING OLIVINE LFP/LMFP ELECTRODES

(71) Applicant: GM Global Technology Operations LLC, Detroit, MI (US)

(72) Inventors: Meiyuan Wu, PUDONG (CN); Dewen Kong, Shanghai (CN); Haijing Liu, Shanghai (CN); Xin Zhang, Shanghai (CN)

(21) Appl. No.: 18/668,788

(22) Filed: May 20, 2024

(30) Foreign Application Priority Data
May 8, 2024 (CN) 202410559908.X

(51) Int. Cl. H01M 4/58; H01M 4/02; H01M 4/04; H01M 4/62; H01M 10/0525

(52) U.S. Cl. CPC H01M 4/5825; H01M 4/0404; H01M 4/0416; H01M 4/624; H01M 10/0525; H01M 2004/028; H01M 2220/20

(57) ABSTRACT

A cathode electrode for a secondary battery, a vehicle battery including the cathode electrode, and a method of forming a cathode for a secondary battery. The cathode electrode includes a cathode disposed on a surface of a cathode current collector, wherein the cathode includes an active material including at least one of lithium iron phosphate and lithium manganese iron phosphate, a binder including polyvinylidene fluoride and polytetrafluoroethylene and a conductive filler.

### BACKGROUND

Electric and hybrid electric vehicle technology is enabled by the development and deployment of rechargeable, secondary batteries, which provide energy to the vehicle powertrain. Secondary batteries include lithium ion batteries, which generally include a cathode, anode, separator, and electrolyte. The cathode provides the source of lithium ions and determines the capacity and average voltage of a battery. The anode stores and releases lithium ions received from the cathode when energy is needed, the separator prevents the cathode and anode from contacting and shorting out the battery, and the electrolyte provides a medium between the cathode and anode through which the lithium ions travel. Energy density, or areal capacity, of the secondary battery may be increased by adding more cathode and anode active material and increasing the density of the cathode and anode.

Cathode electrodes and anode electrodes may be formed by coating current collectors with active cathode material and active anode material, respectively. The coatings often include the active materials, a binder, additives, and a solvent. However, at least in the case of cathodes, it has been found that in simply adding more active cathode material and making a thicker cathode coating layer to increase energy density is complicated by the growth of cracks in the drying process of the coatings as thickness increases. The cracks reduce the integrity of the thicker coating layers and may accelerate parasitic reactions with electrolyte.

Thus, while present lithium cathode chemistries achieve their intended purpose, there is a need for new and improved cathode chemistries that offer improved crack resistance as areal capacity of the cathode material coatings are increased.

### SUMMARY

According to various aspects, the present disclosure is directed to a method of forming a cathode for a secondary battery. The method includes mixing together a solution of polyvinylidene fluoride in N-methyl-2-pyrrolidone, a first dispersion of polytetrafluoroethylene in water, additional N-methyl-2-pyrrolidone, an active material, and conductive fillers to form a slurry. The method further includes coating the slurry onto a cathode current collector and drying the coating and forming a cathode.

In embodiments of the above, the cathode includes the active material, polyvinylidene fluoride, polytetrafluoroethylene, and the conductive fillers, wherein the active material includes at least one of lithium iron phosphate and lithium manganese iron phosphate and the active material is present in the cathode in a range of 89 percent by weight to 97.5 percent by weight of the total weight of the cathode, the polyvinylidene fluoride and polytetrafluoroethylene are present together in a range of 2.1 percent by weight to 6 percent by weight of the total weight of the cathode, and the conductive filler includes at least one of metal wires, metal oxides, carbon nanotubes, carbon black, graphite flake, graphite nanoparticles, and graphite nanoplate and the conductive filler is present in a range of 0.5 percent by weight to 5 percent by weight of the total weight of the cathode.

In any of the above embodiments, the method further includes mixing using a planetary mixer.

In addition, in any of the above embodiments, water is present in the slurry in a range of 0.1 weight percent to 3 weight percent of the total weight of the slurry.

Further, in any of the above embodiments, the slurry is coated onto the cathode current collector by die coating.

In any of the above embodiments, the method further includes mixing the first dispersion of polytetrafluoroethylene in water with the N-methyl-2-pyrrolidone to form a second dispersion, adding the solution of polyvinylidene fluoride in N-methyl-2-pyrrolidone to the second dispersion and forming a third dispersion, adding in a portion of the conductive fillers into the third dispersion, wherein the portion of the conductive fillers are dry conductive fillers, adding in a remainder of the conductive fillers into the third dispersion, wherein the remainder of the conductive fillers are in an aqueous slurry, and forming a fourth dispersion, and adding the active material to the fourth dispersion after mixing in the dry conductive fillers and wet conductive fillers. In further embodiments, the first dispersion of polytetrafluoroethylene in water includes polytetrafluoroethylene present in a range of 10 weight percent to 60 weight percent. Additionally, in any of the embodiments herein, the solution including polyvinylidene fluoride in N-methyl-2-pyrrolidone includes polyvinylidene fluoride present in a range of 5 weight percent to 12 weight percent of the total weight of the solution. In yet further embodiment, N-methyl-2-pyrrolidone is added to the fourth dispersion and adjusting a solids content of the fourth dispersion to a range of 40 percent to 70 percent of the total weight of the fourth dispersion. In yet further embodiments, the method further includes applying vacuum to the third dispersion and the fourth dispersion.

Alternatively, the method includes mixing the active material, a portion of the conductive fillers wherein the portion of the conductive fillers are dry conductive fillers, and polyvinylidene fluoride powder to form a dry mixture, kneading the dry mixture with a solution of polyvinylidene fluoride in N-methyl-2-pyrrolidone and additional N-methyl-2-pyrrolidone to form a dough, mixing N-methyl-2-pyrrolidone to a first dispersion of polytetrafluoroethylene in water and adding the mixture to water to the dough to form a second dispersion, and mixing the second dispersion with a remainder of the conductive fillers, wherein the remainder of the conductive fillers are in an aqueous slurry and forming a third dispersion. In further embodiments, the first dispersion of polytetrafluoroethylene in water includes polytetrafluoroethylene present in a range of 10 weight percent to 60 weight percent. In addition, in embodiments, the solution including polyvinylidene fluoride in N-methyl-2-pyrrolidone includes polyvinylidene fluoride present in a range of 5 weight percent to 12 weight percent of the total weight of the solution. In yet further embodiments, the method includes adding N-methyl-2-pyrrolidone to the third dispersion and adjusting a solids content of the third dispersion to a range of 40 percent to 70 percent of the total weight of the third dispersion. And, in yet further embodiments, the method includes applying vacuum to the third dispersion.

According to various additional aspects, the present disclosure relates to a cathode electrode for a secondary battery. The cathode electrode includes a cathode disposed on the surface of a cathode current collector. The cathode includes an active material including at least one of lithium iron phosphate and lithium manganese iron phosphate. The active material is present in the cathode in a range of 89 percent by weight to 97.5 percent by weight of the total weight of the cathode. The cathode also includes a binder including polyvinylidene fluoride and polytetrafluoroethylene. The binder is present in a range of 2.1 percent by weight to 6 percent by weight of the total weight of the cathode. The cathode further includes conductive filler. The conductive filler is present in a range of 0.5 percent by weight to 5 percent by weight of the total weight of the cathode.

In embodiments of the above, the conductive filler includes at least one of the following: metal wires, metal oxides, carbon nanotubes, carbon black, graphite flake, graphite nanoparticles, and graphite nanoplates.

In any of the above embodiments, the polytetrafluoroethylene is fibrillated.

Further, in any of the above embodiments, the cathode current collector is coated in a layer of carbon particles and a surface area of the cathode current collector is in the range of 25 square meters per gram to 2000 square meters per gram.

According to various additional aspects, the present disclosure is directed to a vehicle battery. The vehicle battery includes a cathode disposed on the surface of a cathode current collector. an anode disposed on an anode current collector, a separator positioned between the anode and cathode, and an electrolyte contacting the anode and the cathode. The cathode includes an active material including at least one of lithium iron phosphate and lithium manganese iron phosphate. The active material is present in the cathode in a range of 89 percent by weight to 97.5 percent by weight of the total weight of the cathode. The cathode also includes a binder including polyvinylidene fluoride and polytetrafluoroethylene. The binder is present in a range of 2.1 percent by weight to 6 percent by weight of the total weight of the cathode. The cathode further includes a conductive filler. The conductive filler is present in a range of 0.5 percent by weight to 5 percent by weight of the total weight of the cathode.

### BRIEF DESCRIPTION OF DRAWINGS

The drawings described herein are for illustration purposes only and are not intended to limit the scope of the present disclosure in any way.

FIG. 1 illustrates a vehicle and a power train including a secondary battery according to embodiments of the present disclosure.

FIG. 2A illustrates a battery according to embodiments of the present disclosure.

FIG. 2B illustrates a pouch or prismatic battery cell according to embodiments of the present disclosure.

FIG. 3 illustrates a method of forming a cathode according to embodiments of the present disclosure.

FIG. 4 illustrates a method of forming a cathode according to embodiments of the present disclosure.

FIG. 5 illustrates a method of forming a cathode according to embodiments of the present disclosure.

FIG. 6 is a micrograph of the active material with binder, including polytetrafluoroethylene fibers, according to embodiments of the present disclosure illustrated at a scale of 1 micrometers.

FIG. 7 illustrates a graph of a first charge and discharge cycle of a 4 milliamp-hour per square centimeter lithium iron phosphate electrode half coin cell at 25 degrees Celsius, wherein the voltage (volts) is illustrated on the y-axis as a function of areal capacity (milliamp-hours per square centimeter) illustrated on the x-axis.

FIG. 8 illustrates a graph of the various discharge rates of a lithium iron phosphate electrode having an areal capacity of 4 milliamp-hours per square centimeter at 25 degrees Celsius, wherein voltage (volts)-depicted on the y-axis is illustrated as a function of areal capacity (milliamp-hours per square centimeter)-depicted on the x-axis.

FIG. 9 illustrates a graph of cycle number versus discharge capacity ratio according to embodiments of the present disclosure for a 4 milliamp-hours per square centimeter lithium iron phosphate electrode at 25 degrees Celsius, wherein discharge capacity ratio is illustrated on the y-axis is illustrated and cycle number is illustrated on the x-axis.

### DETAILED DESCRIPTION

The following description is merely exemplary in nature and is not intended to limit the present disclosure, application, or uses. Furthermore, there is no intention to be bound by any expressed or implied theory presented in the preceding introduction, summary, or the following detailed description. It should be understood that throughout the drawings, corresponding reference numerals indicate like or corresponding parts and features.

Reference will now be made in detail to several examples of the disclosure that are illustrated in accompanying drawings. Whenever possible, the same or similar reference numerals are used in the drawings and the description to refer to the same or like parts or steps. The drawings are in simplified form and are not to precise scale.

Reference to “first,” “second,” “third,” “fourth,” etc. in the specification and claims for designating elements are arbitrary and are intended to assist in the understanding of the disclosure. These references are not necessarily consistent between embodiments or between the specification and claims. In that sense, these references are not intended to limit the elements in any way. The elements are distinguishable by their disposition, description, connections, and function.

The present disclosure is related to an olivine type cathode having an areal density equal to greater than 3.2 milliamp-hours per square centimeter. The olivine type cathode includes at least one of lithium iron phosphate or lithium manganese iron phosphate in a double binder and processes for forming such cathodes using dual solvent slurries in the coating process to make cathodes. The olivine type cathode exhibits a crystal structure similar to the mineral olivine. The cathodes are incorporated into battery cells and secondary batteries, such as prismatic or pouch style batteries. The batteries may then be used in electric or hybrid-electric vehicles.

As used herein, the term “vehicle” is not limited to automobiles. While the present technology is described primarily herein in connection with electric and hybrid-electric vehicles, the technology is not limited to electric and hybrid-electric vehicles. The concepts can be used in a wide variety of applications, such as in connection with components used in motorcycles, mopeds, locomotives, aircraft, marine craft, and other vehicles, as well as in other applications utilizing batteries, such as in portable power stations, such as those used for powering remote job sites, emergency back-up power supplies, and permanent power stations associated with buildings and equipment, all of which may be powered by, for example, solar or wind-powered generator systems, power mains, and fuel based power generators such as gasoline, propane, kerosene, or diesel generators as well as sterling engines.

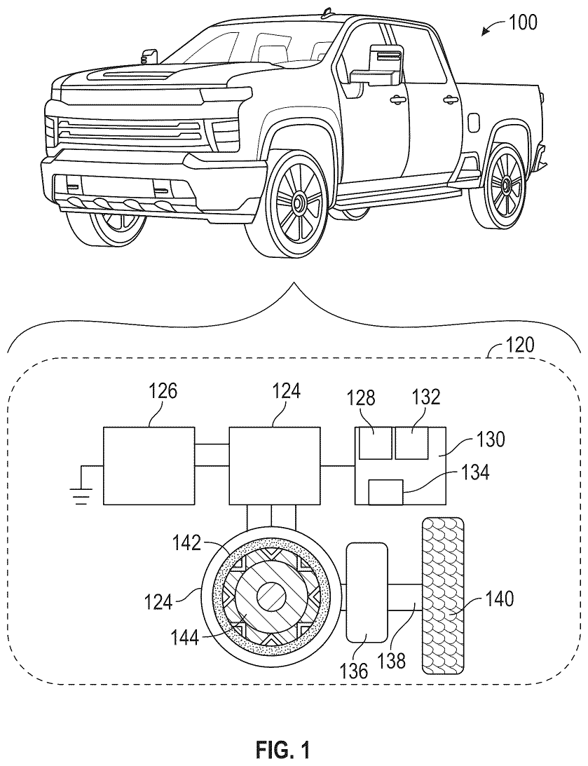

FIG. 1 illustrates a vehicle 100 including a propulsion system 120. The propulsion system 120 generally includes an electric motor 124 and a secondary battery 126 for powering the electric motor 124. Further, in many embodiments, the propulsion system 120 includes an inverter 128 for changing power from DC (direct current) as provided by the battery 126 to AC (alternating current) as it is used by the electric motor 124. The inverter 128 may be included in a power electronics module 130, which includes e.g., transistors and diodes, for switching the power from DC to AC and vice-versa.

A controller 132 is connected to the inverter 128 and is programmed to control and manage the operations of the electric motor 124 and associated hardware, including the inverter 128. The electric motor 124 is connected to a transmission (drive unit) 136, and drive line 138, which transfers mechanical power and rotation to the wheels 140 of the vehicle 100. The controller 132 includes one or more one or more processors and tangible, non-transitory memory 134.

With reference again to the electric motor 124, the electric motor 124, powered by the battery 126, includes a stator 142 and a rotor 144 arranged with the stator 142. The stator 142 is the stationary part of the electric motor 124. The stator 142 provides a rotating magnetic field with which the stationary magnetic field of the rotor 144 tries to align with, causing the rotor 144 to rotate, in what may be referred to as “motoring” mode. In other applications the rotating field of the rotor 144 (as caused by physical rotation) generates an electric current in the stator 142—this mode of operation is referred to as “generation” and the electric motor 124 used in this way is referred to as generator. In traction motor vehicle applications, the motoring mode provides motion to the vehicle 100. Generation mode takes some of the energy recovered from braking when the vehicle is in the process of stopping and stores it back in the vehicle battery 126.

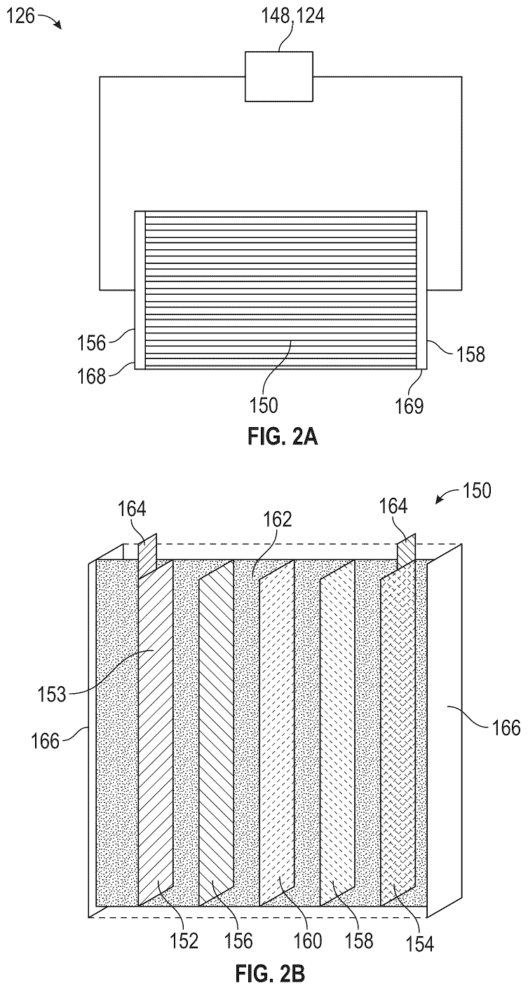

Reference is made to FIGS. 2A and 2B, which illustrate an example of a secondary battery 126 for powering an electric or hybrid electric vehicle 100, such as the electric vehicle 100 illustrated in FIG. 1. As noted above, secondary batteries are understood as rechargeable batteries, that may be discharged upon application of a load and recharged upon the application of an external power source. Referring to FIGS. 2A and 2B, the battery 126 is illustrated as being connected to a load 148, such as the electric motor 124. However, other loads 148 include various systems in the vehicle such as climate control systems and infotainment systems. The battery 126 includes one or more battery cells 150, that are assembled together. The battery cells 150 may be, for example, pouch style or prismatic discussed further below. Alternatively, the battery cells 150 may be cylindrical. During discharge, when a load is applied to the battery 126, Li⁺ ions move from the anode 158 to the cathode 156 through the separator 160 by way of the electrolyte 162. Equivalent electrons e-move through the circuitry 146 from the cathode 156 to the anode 158, providing energy to the load 124. While charging, upon application of an external voltage, Lit ions move from the cathode 156 to the anode 158 by way of the electrolyte 162 through the separator 160 and may be intercalated into the anode 158.

Each battery cell 150, such as those illustrated in FIG. 2B, generally includes a cathode current collector 152, a cathode 156 disposed on the cathode current collector 152, an anode current collector 154, an anode 158 disposed on the anode current collector 154, a separator 160 positioned between the cathode 156 and anode 158, and an electrolyte 162. While the illustrated battery cells 150 include one anode 158 (and anode current collector 154) and one cathode (and one cathode current collector 152), the battery cell 150 may alternatively include two or more cathodes 156 (and cathode current collectors 152) and one or more anodes 158 (and anode current collectors 154). In further alternative embodiments, the battery cell 150 may include or one or more cathodes 156 (and cathode current collectors 152) and two or more anodes 158 (and anode current collectors 154). In any of the designs above, one or more separators 160 are interleaved between the cathodes 156 and anodes 158 to prevent the cathodes 156 and the anodes 158 from contacting.

The battery cell 150 of FIG. 2B may be employed in a pouch style battery cell or in a prismatic battery cell. In either design, where multiple cathodes 156 and multiple anodes 158 are present, separators 160 are provided between the cathodes 156 and anodes 158. In embodiments, a ribbon shaped separator 160 may be z-folded around each cathode 156 (and cathode current collector 152) and around each anode 158 (and anode current collector 154). In a pouch style cell, tabs 164 are welded to the cathode current collectors 152 and the anode current collectors 154 and the covering 166 is in the form of a flexible film pouch formed of aluminum or another material. Prismatic style cells, on the other hand, include terminals that the cathode current collectors 152 and anode current collectors 154 are connected to and the covering 166 is formed of a relatively rigid casing, typically in the form of a cuboid. The tabs 164 or terminals, connected to the cathode current collectors 152, from multiple battery cells 150, which are connected together, such as by a bus bar 168 or other electrical connection. Similarly, the tabs 164 or terminals, connected to the anode current collectors 154, from multiple battery cells 150 are connected together, such as by a bus bar 169 or other electrical connection (see FIG. 2A).

In the various styles of battery cells 150 noted above, the cathode current collector 152 and anode current collector 154 are formed from conductive materials. In embodiments, the cathode current collector 152 includes aluminum. Alternatively, or additionally, the cathode current collector 152 may include copper clad aluminum, and stainless steel. The anode current collector 154 may include one or more of copper, nickel, stainless steel, and titanium. The current collectors 152, 154 are illustrated as being in the form of a foil; however, it should be appreciated that other forms may be exhibited such as mesh. In embodiments, a foil cathode current collector 152 and a foil anode current collector 154 are impermeable to gas. The cathode current collector 152 exhibits a thickness in the range of 5 micrometers to 50 micrometers, including all values and ranges therein, such as in the range of 5 micrometers to 25 micrometers. The anode current collector 154 exhibits a thickness in the range of 4 micrometers to 50 micrometers, including all values and ranges therein, such as in the range of 4 micrometers to 25 micrometers.

The surface area of the cathode current collector 152 may be increased by the addition of a coating or etching. Accordingly, in embodiments, the cathode current collector 152 includes a layer 153 of carbon particles disposed on the surface(s) of the cathode current collector 152 that contacts the cathode 156. In embodiments, the carbon particles exhibit an average particle size in the range of 20 nanometers to 2000 nanometers, including all values and ranges therein, and a surface area in the range of 25 square meters per gram to 2000 square meters per gram, including all values and ranges therein. The thickness of the carbon particle layer 153 on the cathode current collector 152 is in the range of 100 nanometers to 5 micrometers, including all values and ranges therein such as 300 nanometers to 1 micrometer. In alternative or further embodiments, the surface of the cathode current collector 152 on which the cathode is disposed is etched to increase the surface roughness of the cathode current collector 152. In embodiments, the application of the carbon particle layer 153 or etching of the cathode current collector 152 increases the surface area to a surface area in the range of 10 square meters per gram to 20 square meters per gram, including all values and ranges therein, such as 15 square meters per gram.

The cathode 156 includes an active material that provides a source of lithium ions (Li⁺) and can undergo reversible insertion or intercalation of lithium ions, determining e.g., the capacity and average voltage of a battery. In embodiments, the active material includes at least one of lithium iron phosphate (LFP) and lithium manganese iron phosphate (LMFP). In embodiments, the active material is present in the range of 89 percent by weight to 97.5 percent by weight of the total weight of the cathode 156, including all values and ranges therein, such as in the range of 94 percent by weight to 96 percent by weight of the total weight of the cathode 156. In embodiments, the active material is provided as powder.

The lithium iron phosphate exhibits the formula: LiFePO₄. It should be appreciated that additional trace elements may be present, such as carbon, in amount of up to 5.0 percent by weight of the total weight of the lithium iron phosphate. In addition, the lithium iron phosphate exhibits an average primary particle size, as observed by scanning electron microscopy, in the range of 0.1 micrometers to 100 micrometers, including all values and ranges therein such as from 1.0 to 30 micrometers, and a specific surface area, measured using the Brunauer-Emmett-Teller (BET) surface area analysis, in the range of 3 square meters per gram to 50 square meters per gram, including all values and ranges therein, such as 14.7 square meters per gram. Further, the lithium iron phosphate exhibits a tapped density in the range of 0.3 grams per cubic centimeters to 2 grams per cubic centimeters, including all values and ranges therein, such as 2.02 grams per cubic centimeters. Tapped density is understood as the bulk density after mechanically tapping a graduated measuring cylinder or vessel containing the powder sample. The moisture content of the lithium iron phosphate is less than 500 parts per million, such as in the range of 350 parts per million to 450 parts per million. In addition, in embodiments, the lithium iron phosphate exhibits a discharge capacity at C/5 (discharge over 5 hours) of 164 milliamp-hours per gram and at C/2 (discharge over 2 hours) of 162.4 milliamp-hours per gram, as well as a first cycle coulombic efficiency of greater than 99 percent.

The lithium manganese iron phosphate exhibits the formula: LiMnₓFe₍₁₋ₓ₎PO₄, wherein 0<x≤1. In embodiments, the lithium manganese iron phosphate includes one or more of the following compositions: LiMn_{0.6}Fe_{0.4}PO₄, LiMn_{0.7}Fe_{0.3}PO₄, LiMn_{0.75}Fe_{0.25}PO₄, and LiMn_{0.8}Fe_{0.2}PO₄. Alternatively, or additionally, the lithium manganese iron phosphate compositions may be doped with magnesium or aluminum. Thus, the lithium manganese iron phosphate compositions may include one or more of the following composition in addition to, or alternatively to, the compositions noted above, LiMn_{0.7}Mg_{0.05}Fe_{0.25}PO₄ and LiMn_{0.7}Mg_{0.05}Fe_{0.25}PO₄. It should be appreciated that trace elements may be present in the lithium manganese iron phosphate up to 2 percent by weight of the total amount of the lithium manganese iron phosphate. The lithium manganese iron phosphate exhibits an average primary particle size in the range of 10 nanometers to 1000 nanometers, including all values and ranges therein, such as from 20 nanometers to 300 nanometers, and a specific surface area in the range of 5 square meters per gram to 50 square meters per gram, including all values and ranges therein, such as 8 square meters per gram to 25 square meters per gram. In addition, the lithium manganese iron phosphate exhibits a tapped density in the range of 0.3 grams per cubic centimeter to 2.0 grams per cubic centimeters, including all values and ranges therein such as 0.6 grams per cubic centimeters to 0.8 grams per cubic centimeters. The moisture content of the lithium manganese iron phosphate is less than 500 parts per million, such as in the range of 350 parts per million to 450 parts per million. In addition, in embodiments, the lithium manganese iron phosphate exhibits a discharge capacity at C/5 (discharge over 5 hours) of 145 milliamp-hours per gram and at C/2 (discharge over 2 hours) of 140 milliamp-hours per gram, as well as a first cycle coulombic efficiency of greater than 96 percent.

In addition to the active materials, the cathode 156 also includes a binder. The binder is present in the range of 2.1 percent by weight to 6 percent by weight of the total weight of the cathode 156, including all values and ranges therein. The binder includes polyvinylidene fluoride and polytetrafluoroethylene. In embodiments, the polyvinylidene fluoride is present in the range of 2 weight percent to 5.9 weight percent of the total weight of the cathode 156, including all values and ranges therein, such as from 2 weight percent to 4 weight percent of the total weight of the cathode 156. The average molecular weight, Mw, of the polyvinylidene fluoride is in the range of 300000 to 2000000, including all values and ranges therein. In embodiments, a polyvinylidene solution is provided by mixing polyvinylidene fluoride powder with N-methyl-2-pyrrolidone at a temperature in the range of 50 degrees Celsius to 80 degrees Celsius including all values and ranges therein. The polyvinylidene fluoride is provided at a weight percent in the range of 5 percent to 12 percent of the total weight percent of the solution, including all values and ranges therein.

The polytetrafluoroethylene is present in the range of 0.1 weight percent to 2 weight percent of the total weight of the cathode 156, including all values and ranges therein such as in the range of 0.3 weight percent to 0.6 weight percent of the total weight of the cathode 156. The average molecular weight, Mw, of the polytetrafluoroethylene Mn is in the range of 5,000,000 grams per mole to 10,000,000 grams per mole, including all values and ranges therein. The polytetrafluoroethylene is provided as a dispersion in water. In embodiments, the polytetrafluoroethylene is provided in the dispersion in the range of 10 percent by weight to 70 percent by weight of the total weight of the polytetrafluoroethylene-water dispersion, including all values and ranges therein such as 60 percent by weight.

Further, the cathode 156 also includes a conductive filler. The conductive filler includes, for example, one or more of metal wires, metal oxides, carbon nanotubes, carbon black such as SUPER P carbon black available from (IMERYS of Paris, France), graphite flake, graphite nanoparticles, and graphite nanoplates. Carbon nanotubes include at least one of single wall carbon nanotubes and multiwall carbon nanotubes. The conductive filler is present in a range of 0.5 weight percent to 5 weight percent of the total weight of the cathode including all values and ranges therein. In embodiments, carbon black is present in a range of 0.5 percent by weight to 3 percent by weight of the total weight of the cathode, including all values and ranges therein, such as 2.0, graphite flake is present in the range of 0 percent by weight to 1 percent by weight of the total weight of the cathode, including all values and ranges therein, and single wall carbon nanotubes are present in a range of 0 percent by weight to 1 percent by weight of the total weight of the cathode, including all values and ranges therein.

The cathode exhibits a thickness in the range of 80 micrometers to 500 micrometers, including all values and ranges therein, such as 110 micrometers. The cathode electrode, including both the cathode current collector 152 and the cathode 156, when coated on one side of the cathode current collector 152, exhibits a thickness in the range of 85 micrometers to 550 micrometers including all values and ranges therein and when coated on both sides exhibits a thickness in the range of 165 micrometers to 1050 micrometers including all values and ranges therein for a double sided cathode electrode, such as in the range of 205 micrometers to 500 micrometers. In embodiments, the cathode electrode, when coated on a single side with the cathode 156, exhibits a capacity loading in the range of 3 milliamp-hours per square centimeter to 6 milliamp-hours per square centimeter, including all values and ranges therein such as 3.2 milliamp-hours per square centimeter to 4 milliamp-hours per square centimeter at a discharge rate of 0.1C (i.e., a 10 hour discharge) at room temperature, i.e., 21 degrees Celsius to 25 degrees Celsius. Further, the cathode electrode exhibits a pressing density in the range of 2 plus or minus 0.7 grams per cubic centimeter, or 1.5 grams per cubic centimeter to 2.5 grams per cubic centimeter, including all values and ranges therein. The pressing density may be understood as the density of the cathode electrode after compacting using a calendaring process. The porosity of the cathode 156, after compacting using a calendaring process, is in the range of 20 percent by volume to 45 percent by volume of the total volume of the cathode 156. Further, in half coin cells, the cathode electrode exhibits a first charging efficiency of greater than 98 percent, including all values and ranges from 98 percent to 104 percent, a high specific capacity in the range of 150 milliamp-hours per gram to 165 milliamp-hours per gram, including all values and ranges therein such as 161 milliamp-hours per gram, and a discharge rate of 2C/0.33C of greater than 91 percent and 4C/0.33 C of greater than 80 percent.

The anode 158 includes materials that can undergo reversible insertion or intercalation of lithium ions at a lower electrochemical potential than the cathode 156 material, such that an electrochemical potential difference exists between the anode 158 and cathode 156. The anode material may include one or more of lithium metal; alloys of lithium such as lithium silicon alloy, lithium aluminum alloy, lithium indium alloy, lithium titanate, and lithium tin alloy; carbon based materials such as graphite, activated carbon, carbon black and graphene; silicon; silicon based alloys; silicon oxide; silicon based composite materials; tin oxide; aluminum; indium; zinc; germanium; and titanium oxide; as well as any combination of the above. In embodiments, the anode 158 exhibits a thickness in the range of 50 micrometers to 150 micrometers, including all values and ranges therein. In embodiments, the anode 158 is applied to the anode current collector 154, forming a coating on the anode current collector 154, using a deposition process, such as a slurry based process, hot roll pressing process, extrusion or additive manufacturing. The combined anode 158 and anode current collector 154 provide an anode electrode, as referenced further herein.

The separator 160 is a porous material formed of an electrically insulative material that prevents the cathode 156 and anode 158 from contacting and potentially shortening out the circuit. The separator 160 is sandwiched, or at least partially enclosed, between the cathode 156 and anode 158, allowing the passage of the lithium ions and electrolyte 162 through the pores of the separator 160. The separator 160 may include one or more of a composite, a polymeric material, and a non-woven material. In embodiments, the separator includes at least one of polyethylene, polypropylene, polyamide, polytetrafluoroethylene, polyvinylidene fluoride, and polyvinyl chloride. In addition, the separator 160 may be filled, i.e., include fillers dispersed therein, wherein the filler includes a material such as glass fiber. In additional or alternative embodiments, the separator 160 may include at least one of a thermally stable, porous polymer coating and a ceramic coating such as an alumina coating. The coating is disposed on one or more surfaces of a porous polymer film, the polymer film being selected from at least one of polyethylene and polypropylene. The separator 160 may include one or more layers, wherein each layer is formed from one or more of the materials noted above. The separator 160 may take the form of film or a mesh, such as woven mesh or a slit film. In embodiments, the separator 160 exhibits a thickness in the range of 4 micrometers to 25 micrometers, including all values and ranges therein.

The electrolyte 162 provides a medium between the cathode 156 and anode 158 through which lithium ions and the electrolyte travel. The medium may be a liquid, gel, or solid, and capable of conducting the lithium ions between the cathode 156 and the anode 158. The electrolyte 162 permeates the pores of the porous separator 160 and wets, or otherwise contacts, the surfaces of the cathode 156 and anode 158 as well as the separator 160. In embodiments, the electrolyte 162 includes one or more lithium salts dissolved in non-aqueous organic solvent. The lithium salts may include one or more of the following: lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato) borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane) sulfonylimide (LiN(CF₃SO₂)₂), lithium bis(fluorosulfonyl) imide (LiN(FSO₂)₂) (LiSFI), lithium (triethylene glycol dimethy l ether) bis(trifluoromethanesulfonyl) imide (Li(G3)(TFSI), and lithium bis(trifluoromethanesulfonyl) azanide (LiTFSA). The lithium salt may be present in the electrolyte 162 at a concentration (moles of salt per liter of solvent) ranging from 1 M to 4 M, including all values and ranges therein, such as 2 M or 3 M.

The non-aqueous aprotic organic solvent includes or more of various alkyl carbonates, such as cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethylmethylcarbonate (EMC)), aliphatic carboxylic esters (e.g., methyl formate, methyl acetate, methyl propionate), Y-lactones (e.g., γ-butyrolactone, γ-valerolactone), chain structure ethers (e.g., 1,2-dimethoxyethane, 1-2-diethoxyethane, ethoxymethoxy ethane), cyclic ethers (e.g., tetrahydrofuran, 2-methyltetrahydrofuran), 1,3-dioxolane).

Further, the electrolyte 162 may include a number of additives, such as, but not limited to vinyl carbonate, vinyl-ethylene carbonate, propane sulfonate, 1,3,2-dioxathiolane 2,2-dioxide (DTD), LiPF₂O₂, and combinations thereof. Other additives can include diluents which do not coordinate with lithium ions but can reduce viscosity of the electrolyte 162, such as bis(2,2,2-trifluoroethyl) ether (BTFE), and flame retardants, such as triethyl phosphate.

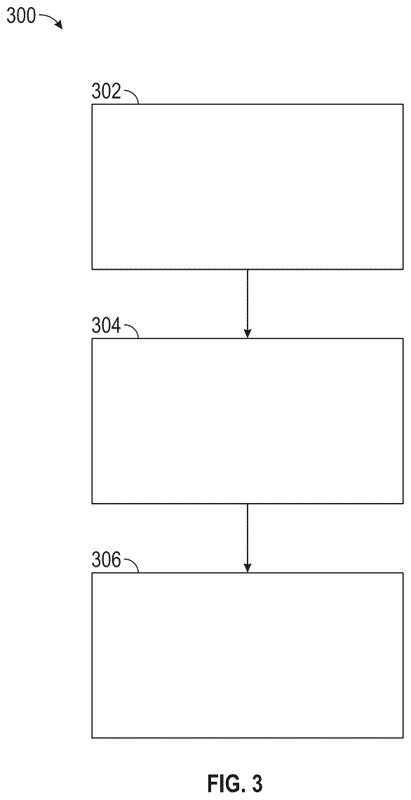

The cathodes 156 described above are formed by forming a slurry and coating the slurry onto the cathode current collectors 152. As illustrated in FIG. 3, methods of forming cathode coatings generally include mixing the binders at block 302 including the dispersion of polytetrafluoroethylene in water with a N-methyl-2-pyrrolidone dispersion medium and the polyvinylidene in N-methyl-2-pyrrolidone solution, the active materials, and the conductive fillers to form a slurry. At block 304, the slurry is coated onto a cathode current collector 152 to form the cathode 156 using a coating process such as die coating, roll coating, dip coating, etc. At block 306 the coating is dried and dispersion medium and solvents that have not already evaporated from the slurry are removed from the coating. In embodiments, the process begins with blending the binders, forming a dispersion, mixing in the powder materials into the dispersion, and adjusting the solids content to obtain a desired slurry consistency for coating to form the cathode. In alternative embodiments, the process begins with dry mixing the powders, adding the binders and forming a dispersion, and then adjusting the solids content to obtain a desired slurry consistency for coating to form the cathode. In any of the above processes, once the slurry is formed, the cathode current collector is coated with the coating to form the cathode and the dispersion media/solvents are removed. Further, the processes utilize two solvents, i.e., are a dual solvent system. Without being bound to any particular theory, the two solvents allows for the tuning of the evaporation rate during the cathode coating drying process, which is understood to suppress surface cracks in the cathode 156.

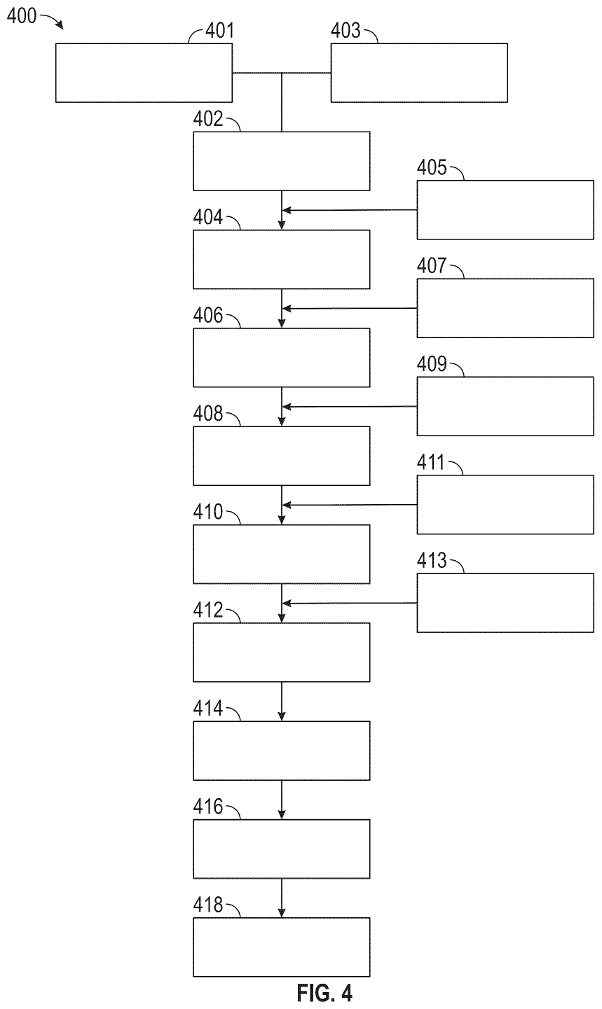

FIG. 4 illustrates an embodiment of a method 400 of forming a slurry to create a cathode 156. At block 402, a dispersion medium of N-methyl-2-pyrrolidone 401 is mixed with a first dispersion of polytetrafluoroethylene 403 in water to form a second dispersion. As noted above, the polytetrafluoroethylene is provided in the first dispersion in water in the range of 10 percent by weight to 70 percent by weight of the total weight of the first dispersion, including all values and ranges therein such as 60 percent by weight. In embodiments, mixing occurs at a speed in the range of 20 rotations per minute to 500 rotations per minute, including all values and ranges therein, for a first mixing time period in the range of 10 minutes to 20 minutes, including all values and ranges therein, such as 15 minutes.

At block 404 the polyvinylidene fluoride solution 405, including polyvinylidene fluoride provided in N-methyl-2-pyrrolidone at a weight percent in the range of 5 percent to 12 percent of the total weight percent of the solution noted above, is mixed into the second dispersion forming a third dispersion. Mixing occurs at a speed in the range of 20 rotations per minute to 1000 rotations per minute, including all values and ranges therein, for a first mixing time period in the range of 20 minutes to 40 minutes, including all values and ranges therein, such as 30 minutes.

At block 406 one or more dry conductive fillers 407 is mixed into the third dispersion containing both binders. The dry conductive fillers form a portion of the conductive fillers added to the coating. Alternatively, the dry conductive fillers are the only fillers added to the third dispersion. In embodiments, the conductive fillers include carbon black and graphite flake. However, any of the conductive fillers noted above, or additional conductive fillers, may be added at this time. The dispersion including the dry conductive fillers is mixed at a speed in the range of 30 rotations per minute to 2000 rotations per minute, including all values and ranges therein, for a first mixing time period in the range of 20 minutes to 40 minutes, including all values and ranges therein, such as 30 minutes.

At block 408 one or more wet conductive fillers 409, i.e., conductive fillers provided in an aqueous slurry, are mixed into the third dispersion forming a fourth dispersion. In embodiments, the wet conductive fillers form the remainder of the conductive fillers added to the third dispersion. Alternatively, the wet conductive fillers are the only fillers added to the third dispersion. In embodiments, carbon nanotubes in a slurry are added to the third dispersion. However, any of the conductive fillers noted above, or additional conductive fillers present in a dispersion or solution, may be added at this time. The fourth dispersion including the wet conductive fillers are mixed at a speed in the range of 30 rotations per minute to 2000 rotations per minute, including all values and ranges therein, for a first mixing time period in the range of 20 minutes to 40 minutes, including all values and ranges therein, such as 30 minutes. While it is illustrated that block 408 occurs after block 406, it should be appreciated that, in alternative embodiments, block 408 may occur before block 406 or simultaneously with block 406.

At block 410 an active material 411 is added to the fourth dispersion. The active material may be added as a dry powder or as a wet powder in a dispersion or solution. The fourth dispersion including the active material is mixed under vacuum at a speed in the range of 30 rotations per minute to 3000 rotations per minute, including all values and ranges therein, for a first mixing time period in the range of 40 minutes to 80 minutes, including all values and ranges therein, such as 60 minutes. While it is illustrated that block 410 occurs after blocks 406 and 408, block 410 may occur simultaneously with either block 406 or 408 or before blocks 406 and 408.

At block 412 N-methyl-2-pyrrolidone 413 is added to the fourth dispersion and mixed under vacuum at a speed in the range of 30 rotations per minute to 2000 rotations per minute, including all values and ranges therein, for a first mixing time period in the range of 5 minutes to 30 minutes, including all values and ranges therein, such as 15 minutes. The amount of N-methyl-2-pyrrolidone is adjusted to obtain a solids content in the range of 40 percent to 70 percent by weight of the total weight of the slurry including all values and ranges therein, such as in the range of 45 percent by weight to 65 percent by weight of the total weight of the slurry.

At block 414 mixing is continued to form the slurry. Water is present in the slurry in a range of 0.05 percent by weight to 5 percent by weight of the total weight of the slurry, including all values and ranges therein, such as 0.1 percent by weight to 3 percent by weight of the total weight of the slurry. The dispersion is mixed under vacuum at a speed in the range of 20 rotations per minute to 500 rotations per minute, including all values and ranges therein, for a first mixing time period in the range of 20 minutes to 40 minutes, including all values and ranges therein, such as 30 minutes.

At block 416 the slurry is used to coat the cathode current collector 152, described above. The slurry coating is applied to the cathode current collector 152 using a coating process such as die coating. Alternatively, other slurry coating processes such as spray coating or roll coating. At block 418, any remaining N-methyl-2-pyrrolidone is recovered from the slurry and coating, such that the amount of N-methyl-2-pyrrolidone in the coating is less than 0.1 percent by weight, including all values and ranges therein, such as 0 percent to 0.1 percent. The water content of the coating is reduced to less than 500 parts per million, including all values and ranges in the range of 0 parts per million to 500 parts per million.

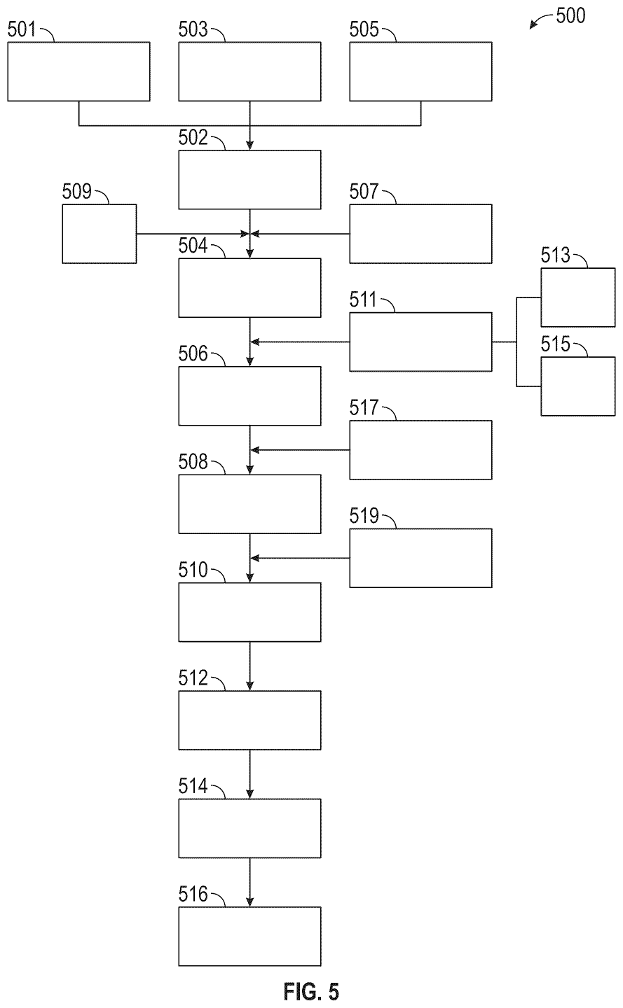

FIG. 5 illustrates another embodiment of a method 500 of forming a cathode 156. At block 502 the dry ingredients including the active material 501 and one or more dry conductive fillers 503, 505 are dry mixed together to form a dry mixture. In one embodiment, the dry conductive fillers include carbon black and graphite flake. The dry powder is mixed at a speed in the range of 20 rotations per minute to 500 rotations per minute, including all values and ranges therein, for a first mixing time period in the range of 20 minutes to 40 minutes, including all values and ranges therein, such as 30 minutes.

At block 504 a solution of polyvinylidene fluoride in N-methyl-2-pyrrolidone 507, prepared as described above, is added to the dry mix with additional N-methyl-2-pyrrolidone 509 to form a dough. The mixture is kneaded at a speed in the range of 40 rotations per minute to 1000 rotations per minute, including all values and ranges therein, for a first mixing time period in the range of 20 minutes to 40 minutes, including all values and ranges therein, such as 30 minutes.

At block 506, a first dispersion 511 of polytetrafluoroethylene in water mixed 513 with N-methyl-2-pyrrolidone 515 is added to the dough forming a second dispersion. The second dispersion is mixed at a speed in the range of 30 rotations per minute to 3000 rotations per minute, including all values and ranges therein, for a first mixing time period in the range of 40 minutes to 80 minutes, including all values and ranges therein, such as 60 minutes.

At block 508 wet conductive fillers 517, i.e., conductive fillers dispersed in a dispersion medium or solvent, are added to the second dispersion, forming a third dispersion. In embodiments, carbon nanotubes in a slurry are added to the second dispersion. However, any of the conductive fillers noted above, or additional conductive fillers present in a dispersion or solution, may be added at this time. The third dispersion including the wet conductive fillers are mixed at a speed in the range of 30 rotations per minute to 3000 rotations per minute, including all values and ranges therein, for a first mixing time period in the range of 20 minutes to 40 minutes, including all values and ranges therein, such as 30 minutes. While it is illustrated that block 508 occurs after block 506, it should be appreciated that, in alternative embodiments, block 508 may occur before block 506 or simultaneously with block 506.

At block 510 N-methyl-2-pyrrolidone 519 is mixed in the dispersion under vacuum at a speed in the range of 30 rotations per minute to 2000 rotations per minute, including all values and ranges therein, for a first mixing time period in the range of 20 minutes to 40 minutes, including all values and ranges therein, such as 30 minutes. The amount of N-methyl-2-pyrrolidone is adjusted to obtain a solids content in the range of 40 percent to 70 percent by weight of the total weight of the slurry including all values and ranges therein, such as in the range of 45 percent by weight to 65 percent by weight of the total weight of the dispersion.

At block 512 mixing is continued to form the slurry. Water is present in the slurry in a range of 0.05 percent by weight to 5 percent by weight of the total weight of the slurry, including all values and ranges therein, such as 0.1 percent by weight to 3 percent by weight of the total weight of the slurry. The dispersion is mixed under vacuum at a speed in the range of 20 rotations per minute to 500 rotations per minute, including all values and ranges therein, for a first mixing time period in the range of 20 minutes to 40 minutes, including all values and ranges therein, such as 30 minutes.

At block 514 the slurry is used to coat the cathode current collector 152, described above. The slurry coating is applied to the cathode current collector 152 using a coating process such as die coating. Alternatively, other slurry coating processes such as spray coating or roll coating. At block 516, any remaining N-methyl-2-pyrrolidone is recovered from the slurry and coating, such that the amount of N-methyl-2-pyrrolidone in the coating is less than 0.1 percent by weight, including all values and ranges therein, such as 0 percent to 0.1 percent. The water content of the coating is reduced to less than 500 parts per million, including all values and ranges in the range of 0 parts per million to 500 parts per million.

In the methods described above in FIGS. 3 through 5, a mixer capable of exhibiting speeds of up to 10,000 rotations per minute, including all values and ranges from 10 rotations per minute to 10,000 rotations per minute. In embodiments, the mixer is a planetary mixer. In addition, or alternatively, other mixers may be used.

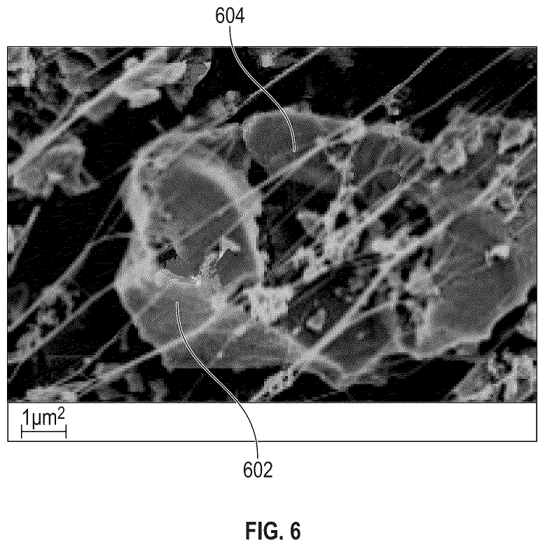

An embodiment of a resulting cathode electrode is illustrated in FIG. 6, which shows a micrograph at 1 micrometer scale of the active material 602 and binder 604, forming the cathode 156, on the cathode current collector 152. As illustrated, the active material 602 and polyvinylidene fluoride remain relatively particle shaped. However, the polytetrafluoroethylene in the binder 604 is fibrillated and forms fibers that are generally orientated axially in a given direction. The direction of orientation of the fibers of the polytetrafluoroethylene is, in embodiments, induced by the coating process and forms a web over the active material 602.

### Example

A cathode electrode was constructed following the method illustrated in FIG. 4 using 94 weight percent of lithium iron phosphate, 2 weight percent carbon black, 0.5 weigh percent graphite flake, 0.1 weight percent carbon nanotube, 3 weight percent of polyvinylidene fluoride, and 0.4 weight percent of polytetrafluoroethylene, wherein the weight percent is the weight percent of the total weight of the cathode. The solids content of the slurry was adjusted to 50 percent by weight solids of the total weight of the slurry. The cathode was observed to exhibit flexibility without cracking when applied to rods of various diameters of 8 millimeters, 10 millimeters, and 18 millimeters.

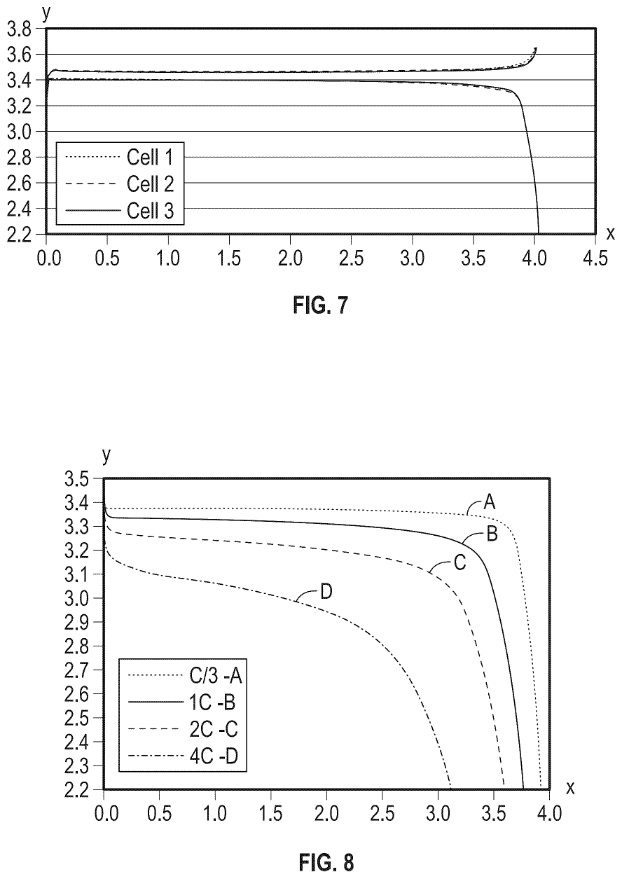

The cathode coating was applied to three aluminum electrode which were used to provide three half coin cells. The cathode electrode of the half coin cells exhibited a 4 milliamp-hour per square centimeter areal density. FIG. 7 illustrates the areal capacity, milliamp-hours per square centimeter (on the x-axis), versus the voltage, volts (on the y-axis) measured. Charging was applied from 2.2 volts to 3.65 volts at a charge rate of C/20 (20 hours) under constant current mode to 3.65V, then changes to constant voltage charge mode, the cut-off current is C/100, and at a discharge rate of C/20 to 2.2V. As can be seen in the graph, the three half cells performed relatively consistently. The average first charge coulombic efficiency of the three half coin cells was determined at 25 degrees Celsius. Table 1 below shows the charge milliamp-hour per gram (mAh/g), discharge milliamp-hour per gram (mAh/g), columbic efficiency percentage (%), and average columbic efficiency percentage (%).

TABLE 1
Charge, Discharge, and Columbic Efficiency

| | Charge | Discharge | Columbic | Average Columbic |
|---|---|---|---|---|
| Cell No. | (mAh/g) | (mAh/g) | Efficiency % | Efficiency % |
| 1 | 160.7 | 161.6 | 100.6 | 100.4 |
| 2 | 161.1 | 161.5 | 100.3 | |
| 3 | 160.8 | 161.3 | 100.3 | |

The electrode discharge rates were tested at 25 degrees Celsius using one of the half coin cells. FIG. 8 illustrates the effect of discharge rate on voltage (volts) as a function of areal capacity (milliamp-hours per square centimeter). The discharge rates tested were C/3 (3 hours), 1C (1 hour discharge time), 2C (½ hour discharge time), and 4C (15 minute discharge time). At a 2C discharge rate, the battery retains 91 percent of its capacity and at a 4C discharge rate, the battery retains 80 percent of its capacity.

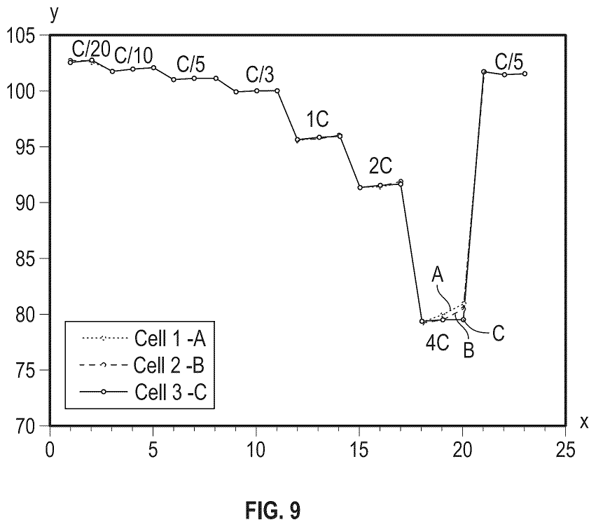

The discharge capacity, expressed as a percentage of the actual discharge rate to the discharge rate as C/3, for the three half coin cells as a function of cycle number is illustrated in FIG. 9. As seen in the figure, the discharge capacity decreases as the discharge rate increases; however, as the discharge rate is returned to C/5, the discharge capacity returns. The discharge rates tested include two tests at C/20 (discharge over 20 hours), C/10 (discharge over 10 hours), C/5 (discharge over 5 hours), C/3 (discharge over 3 hours), 1C (discharge over 1 hour), 2C (discharge over a half hour), and 4C (discharge over 15 minutes). All three half cells demonstrated similar trends.

The cathodes, battery cells, secondary batteries, and methods of making described herein offer a number of advantages. These advantages include, for example, the ability to produce an olivine type cathode (including one or both of lithium iron phosphate and lithium manganese iron phosphate) exhibiting an areal density of 3.2 milliamp-hours per square centimeter or greater. In addition, the use of the dual solvent system in forming the cathode suppresses surface cracks in the cathode coating. Further, in half coin cells, the cathode electrode exhibits a first charging efficiency of greater than 98 percent, including all values and ranges from 98 percent to 104 percent, a high specific capacity in the range of 150 milliamp-hours per gram to 165 milliamp-hours per gram, including all values and ranges therein such as 161 milliamp-hours per gram, and a discharge rate of 2C/0.33C of greater than 91 percent and 4C/0.33 C of greater than 80 percent.

As used herein, the term “controller” and related terms such as microcontroller, control module, module, control, control unit, processor and similar terms refer to one or various combinations of Application Specific Integrated Circuit(s) (ASIC), Field-Programmable Gate Array (FPGA), electronic circuit(s), central processing unit(s), e.g., microprocessor(s) and associated non-transitory memory component(s) in the form of memory and storage devices (read only, programmable read only, random access, hard drive, etc.). The controller 132 may also consist of multiple controllers which are in electrical communication with each other. The controller 132 may be inter-connected with additional systems and/or controllers of the vehicle 100, allowing the controller 132 to access data such as, for example, speed, acceleration, braking, and steering angle of the vehicle 100.

A processor may be a custom made or commercially available processor, a central processing unit (CPU), a graphics processing unit (GPU), an auxiliary processor among several processors associated with the controller 132, a semi composite conductor-based microprocessor (in the form of a microchip or chip set), a macroprocessor, a combination thereof, or generally a device for executing instructions.

The tangible, non-transitory memory 134 may include volatile and nonvolatile storage in read-only memory (ROM), random-access memory (RAM), and keep-alive memory (KAM), for example. KAM is a persistent or non-volatile memory that may be used to store various operating variables while the processor is powered down. The tangible, non-transitory memory 134 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the controller 132 to control various systems of the vehicle 100.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method of forming a cathode for a secondary battery, comprising:
mixing together a solution of polyvinylidene fluoride in N-methyl-2-pyrrolidone, a first dispersion of polytetrafluoroethylene in water, additional N-methyl-2-pyrrolidone, an active material, and conductive fillers to form a slurry;
coating the slurry onto a cathode current collector; and
drying the coating and forming a cathode.

2. The method of claim 1 wherein the cathode includes the active material, polyvinylidene fluoride, polytetrafluoroethylene, and the conductive fillers, wherein the active material includes at least one of lithium iron phosphate and lithium manganese iron phosphate and the active material is present in the cathode in a range of 89 percent by weight to 97.5 percent by weight of the total weight of the cathode, the polyvinylidene fluoride and polytetrafluoroethylene are present together in a range of 2.1 percent by weight to 6 percent by weight of the total weight of the cathode, and the conductive filler includes at least one of metal wires, metal oxides, carbon nanotubes, carbon black, graphite flake, graphite nanoparticles, and graphite nanoplate and the conductive filler is present in a range of 0.5 percent by weight to 5 percent by weight of the total weight of the cathode.

3. The method of claim 2, further comprising:
mixing the first dispersion of polytetrafluoroethylene in water with the N-methyl-2-pyrrolidone to form a second dispersion;
adding the solution of polyvinylidene fluoride in N-methyl-2-pyrrolidone to the second dispersion and forming a third dispersion;
adding in a portion of the conductive fillers into the third dispersion, wherein the portion of the conductive fillers are dry conductive fillers;
adding in a remainder of the conductive fillers into the third dispersion, wherein the remainder of the conductive fillers are in an aqueous slurry, and forming a fourth dispersion; and
adding the active material to the fourth dispersion after mixing in the dry conductive fillers and wet conductive fillers.

4. The method of claim 3, wherein the first dispersion of polytetrafluoroethylene in water includes polytetrafluoroethylene present in a range of 10 weight percent to 60 weight percent.

5. The method of claim 3, wherein the solution including polyvinylidene fluoride in N-methyl-2-pyrrolidone includes polyvinylidene fluoride present in a range of 5 weight percent to 12 weight percent of the total weight of the solution.

6. The method of claim 3, further comprising:
adding N-methyl-2-pyrrolidone to the fourth dispersion and adjusting a solids content of the fourth dispersion to a range of 40 percent to 70 percent of the total weight of the fourth dispersion.

7. The method of claim 6, further comprising:
applying vacuum to the third dispersion and the fourth dispersion.

8. The method of claim 2, further comprising:
mixing the active material, a portion of the conductive fillers wherein the portion of the conductive fillers are dry conductive fillers, and polyvinylidene fluoride powder to form a dry mixture;
kneading the dry mixture with a solution of polyvinylidene fluoride in N-methyl-2-pyrrolidone and additional N-methyl-2-pyrrolidone to form a dough;
mixing N-methyl-2-pyrrolidone to a first dispersion of polytetrafluoroethylene in water and adding the mixture to water to the dough to form a second dispersion; and
mixing the second dispersion with a remainder of the conductive fillers, wherein the remainder of the conductive fillers are in an aqueous slurry and forming a third dispersion.

9. The method of claim 8, wherein the first dispersion of polytetrafluoroethylene in water includes polytetrafluoroethylene present in a range of 10 weight percent to 60 weight percent.

10. The method of claim 8, wherein the solution including polyvinylidene fluoride in N-methyl-2-pyrrolidone includes polyvinylidene fluoride present in a range of 5 weight percent to 12 weight percent of the total weight of the solution.

11. The method of claim 8, further comprising:
adding N-methyl-2-pyrrolidone to the third dispersion and adjusting a solids content of the third dispersion to a range of 40 percent to 70 percent of the total weight of the third dispersion.

12. The method of claim 11, further comprising applying vacuum to the third dispersion.

13. The method of claim 1, wherein mixing is performed with a planetary mixer.

14. The method of claim 1, wherein water is present in the slurry in a range of 0.1 weight percent to 3 weight percent of the total weight of the slurry.

15. The method of claim 1, wherein the slurry is coated onto the cathode current collector by die coating.

16. A cathode electrode for a secondary battery, comprising:
a cathode disposed on a surface of a cathode current collector, the cathode including an active material including at least one of lithium iron phosphate and lithium manganese iron phosphate, wherein the active material is present in the cathode in a range of 89 percent by weight to 97.5 percent by weight of the total weight of the cathode,
a binder including polyvinylidene fluoride and polytetrafluoroethylene, wherein the binder is present in a range of 2.1 percent by weight to 6 percent by weight of the total weight of the cathode, and a conductive filler, wherein the conductive filler is present in a range of 0.5 percent by weight to 5 percent by weight of the total weight of the cathode.

17. The cathode electrode of claim 16, wherein the conductive filler includes at least one of the following: metal wires, metal oxides, carbon nanotubes, carbon black, graphite flake, graphite nanoparticles, and graphite nanoplates.

18. The cathode electrode of claim 16, wherein the polytetrafluoroethylene is fibrillated.

19. The cathode electrode of claim 16, wherein the cathode current collector is coated in a layer of carbon particles and a surface area of the cathode current collector is in the range of 25 square meters per gram to 2000 square meters per gram.

20. A vehicle battery, comprising:
a cathode disposed on a surface of a cathode current collector, the cathode including
an active material including at least one of lithium iron phosphate and lithium manganese iron phosphate, wherein the active material is present in the cathode in a range of 89 percent by weight to 97.5 percent by weight of the total weight of the cathode,
a binder including polyvinylidene fluoride and polytetrafluoroethylene, wherein the binder is present in a range of 2.1 percent by weight to 6 percent by weight of the total weight of the cathode, and
a conductive filler, wherein the conductive filler is present in a range of 0.5 percent by weight to 5 percent by weight of the total weight of the cathode;
an anode disposed on an anode current collector;
a separator positioned between the anode and cathode; and
an electrolyte contacting the anode and the cathode.
